(19) United States
(12) Patent Application Publication
(10) Pub. No.: US 2007/0150115 A1
(43) Pub. Date: Jun. 28, 2007

(54) Operation and design of integrated circuits at constrained temperature ranges in accordance with bit error rates

(75) Inventors: Leonard Forbes, Corvallis, OR (US); Paul A. Farrar, Okatie, SC (US)

Correspondence Address: WONG, CABELLO, LUTSCH, RUTHERFORD & BRUCCULERI,;L.L.P., 20333 SH 249, SUITE 600, HOUSTON, TX, 77070, US

(73) Assignee: Micron Technology, Inc., Boise, ID (US)

(21) Appl. No.: 11/319,963

(22) Filed: Dec. 27, 2005

(51) Int. Cl. G05D 23/00

(52) U.S. Cl. 700/299

(57) ABSTRACT

An improved system and associated methods for the operation and design of integrated circuits at constrained temperature ranges in accordance with bit error rates is disclosed. In one embodiment, a computer is used to derive an operational temperature for the integrated circuit from an assumed bit error rate using the Rice formula. The integrated circuit is then controlled to that temperature by any known temperature-controlling means. Input of the variables to the Rice equation may come from a design module typically used in the design of the integrated circuit, or may be entered by the user based on user preferences. In an alternative embodiment, the system may also be used to design the integrated circuit, again by using the Rice formula. In this application, design tolerances from the design module are modified in accordance with predicted temperatures from the Rice formula, and once design tolerances are deduced to produce a suitable bit error rate, the integrated circuit is designed accordingly using the modified design tolerances, and the to-be-fabricated integrated circuit is then controlled to the predicted temperature.

### FIELD OF THE INVENTION

Embodiments of this invention relate to predictably setting temperature operating limits on an integrated circuit in accordance with a desired or tolerable bit error rate, and to adjusting design tolerances used in such integrated circuits that will operate at such temperature operating limits.

### BACKGROUND

As integrated circuit technology continues to progress, certain physical limits are being reached that tend to impede further development. For example, as concerns the design of an integrated circuit, it becomes increasingly more difficult to continue to merely shrink the size of the transistors and other devices that make up an integrated circuit. This is because, among other effects, as devices become smaller, they begin to increasingly suffer from various forms of current leakage. Such current leakage is generally a function of distance, and for example can effect the isolation structures meant to prevent cross talk. For example, in a transistor, both the gate oxide insulation and the source-to-drain spacing between the junctions will increasingly leak as their thicknesses or spacings continue to shrink.

Current leakage, as well as being a function of distance, is also generally a function of temperature. Thus, these same leakage mechanisms, whether they occur through dielectrics or by junctions, will increase (generally, exponentially) as a function of temperature.

The result of these effects is that the dimensions of the devices on integrated circuits must generally be designed in accordance with various design rules to ensure that such leakage effects do not occur at specified operating temperatures for the integrated circuit. For example, assume an integrated circuit might need to work in a particular temperature range, such as might be dictated by commercial or military specifications. Assume that this temperature ranges from −15 degrees Celsius (a normal but cold environment) and 75 degrees Celsius (a hot, possibly industrial environment). Given this temperature operating range, it may be dictated that the junction spacing in the integrated circuit can be no smaller than 150 nanometers, lest the leakage be too severe. In this example, this 150-nanometer design tolerance is largely dictated by the upper temperature specified in the permissible operating range (i.e., 75C), although other deleterious effects other than leakage can occur at the lower end of the temperature range as well.

But a 150-nanometer design tolerance may be highly unfortunate, and essentially may dictate that more space be used on the integrated circuit's surface than is desired. Moreover, such a conservative approach to designing the integrated circuit may not be warranted, especially when it is considered that the integrated circuit may not be used in a high temperature environment (i.e., 75C) which ultimately dictated the 150-nanometer deign constraint, and/or when it is considered that the temperature of the integrated circuit might be controllable.

As regards temperature control, it has been suggested in the art to hold the operation of integrated circuit to a narrower, and usually cooler temperature range by various cooling mechanisms. For example, U.S. patent applications Ser. No. 10/930,252, filed Aug. 31, 2004, and Ser. No. 11/001,930, filed Dec. 2, 2004, both of which are assigned to the same assignee of the present application and both of which are incorporated herein by reference, disclose various ways of cooling an integrated circuit to particular range of operating temperatures or to a temperature set point. Additional integrated cooling mechanisms are disclosed in U.S. Pat. Nos. 6,588,217 and 5,966,940, which are both incorporated herein by reference.

While it is generally recognized that the controlling the operating temperature of an integrated circuit can be beneficial to its operation, and can allow for a relaxation of design tolerances (e.g., smaller junction spacings), the art has apparently done little to quantify the improvements that such reduced temperature operation can bring. In other words, the art recognizes that certain effects, such as leakage currents, are reduced at lower operating temperatures, but does little to suggest how lower operating temperatures will actually affect the performance of a real integrated circuit, with all of its attendant complexities.

That being said, prior art does exist which is generally pertinent to the quantification of error in an integrated circuit. For example, the art has recognized that a bit error rate of a logic circuit, i.e., the percentage of erroneous bits in an otherwise proper output stream of bits from the circuit, is quantifiable in accordance with the Rice formula, which states as follows:
v=(2/\sqrt{3})*exp(−Uth²/2Un²)*f_{c}
where v=the mean frequency of bit errors; Uth=a voltage threshold of a particular logic circuit involved in output the stream of bits, past which a bit error may be produced; Un=the root-mean-squared (rms) thermal noise voltage; and fc=the bandwidth of the thermal noise. (For more information concerning the Rice formula, see also L. B. Kish, “Moore's Law and the Energy Requirement of Computing Versus Performance, IEE Proc.—Circuits Devices Syst., Vol. 151 No. 2, pp. 190-192 (April 2004), which is incorporated herein by reference in its entirety). In short, the Rice formula recognizes that Gaussian-distributed thermal noise voltages, like leakage currents, can cause bit failures. (In effect, there is little difference between thermal noise and the leakage currents discussed earlier. Hence, from this point forward, thermal noise is discussed as a more general proxy for the concept of thermally-induced current leakage).

FIG. 1 shows a simple RC circuit for the purpose of modeling the thermal noise voltage, Un, and provides an increased appreciation of the operation of the Rice formula. As illustrated, the rms thermal noise voltage across the resistor, R, is Un=\sqrt{4kTR}, and across the capacitor, C, is Un=\sqrt{kT/C}, where k comprises the Boltzmann constant (k=8.12×10⁻⁵ eV/K). Additionally, and although not shown, the bandwidth of such noise, fc, is equal to ½πRC. (See Kish, incorporated above). This is useful to recognize, because such an RC circuit well models the fundamentals of the structure of many aspects of typical CMOS circuitry. Thus, in a realistic inverter circuit as shown in FIG. 2, we see the same basic RC circuit, and hence the same thermal noise voltages are apparent, with R representing the resistance either of the transistors in the first inverter stage 24, and C representing the input capacitance of the second inverter stage 26.

Such thermal noise on the input of the inverter 26, Un=\sqrt{kT/C}, has the potential to perturb the operation of the inverter 26, potentially causing a bit error. Appreciation of this fact can be better had via a review of the input/output curve of exemplary inverter 26, as shown in FIG. 3. Note that the inverter 26, like all logic circuits, has voltage thresholds, Uth, outside of which a bit error might occur, i.e., in which a specified input does not reliably provide the desired output. As concerns the inverter 26, two voltage thresholds are apparent for both the input of a logic ‘0’ (Uth₀) and a logic ‘1’ (Uth₁).

Thus, thermal noise, Un, statistically speaking, has a probability of surpassing the voltage threshold, Uth, of a given circuit with the result that the circuit may output a bit error. Again, the Rice formula quantifies the probability at which such bit rate errors will occur (v) as a function of both Un and Uth.

However, note that the Rice formula also quantifies bit rate errors as a function of temperature as well. Specifically, because Un=\sqrt{kT/C} in the exemplary circuit illustrated, v can ultimately be described as a function of temperature. However, despite this dependency, it is believed that the literature describing the Rice formula does not emphasize that bit error rate can be controlled through the proper application of temperatures to an operating integrated circuit. Moreover, literature describing the Rice formula does not emphasize that the Rice formula can be used in the design, and specifically in setting the design tolerances, of integrated circuitry.

Hence, it is a goal of this disclosure to use the Rice formula to determine the appropriate temperature operating limits for a desired or tolerable bit error rate, and additionally to use such information to improve the design of integrated circuits that will operate at such temperatures.

### SUMMARY

An improved system and associated methods for the operation and design of integrated circuits at constrained temperature ranges in accordance with bit error rates is disclosed. In one embodiment, a computer is used to derive an operational temperature for the integrated circuit from an assumed bit error rate using the Rice formula. The integrated circuit is then controlled to that temperature by any known temperature-controlling means. Input of the variables to the Rice equation may come from a design module typically used in the design of the integrated circuit, or may be entered by the user based on user preferences. In an alternative embodiment, the system may also be used to design the integrated circuit, again by using the Rice formula. In this application, design tolerances from the design module are modified in accordance with predicted temperatures from the Rice formula, and once design tolerances are deduced to produce a suitable bit error rate, the integrated circuit is designed accordingly using the modified design tolerances, and the to-be-fabricated integrated circuit is then controlled to the predicted temperature. In another alternative embodiment, the operating frequency of the integrated circuit is controlled to control the operating temperature and hence the bit error rates.

### BRIEF DESCRIPTION OF THE DRAWINGS

Embodiments of the inventive aspects of this disclosure will be best understood with reference to the following detailed description, when read in conjunction with the accompanying drawings, in which:

FIG. 1 shows an RC circuit of the prior art, and shown the thermal noise voltage associated with each element.

FIG. 2 shows a CMOS inverter circuit analogous to the RC circuit of FIG. 1, and hence shows the thermal noise voltage as associated with the input of an inverter.

FIG. 3 shows an input/output curve for an inverter, and shows the presence of input voltage thresholds within which the output is predictable.

FIG. 4 shows a system in accordance with an embodiment of the invention for computing an operating temperature in accordance with the Rice formula, and for holding the integrated circuit to that temperature.

### DETAILED DESCRIPTION

Central to this disclosure is to use the Rice formula to a more constructive end than the mere realization of the statistical reality of bit error rates. Instead, the Rice formula is used to predict a temperature at which the bit rate error will be deemed acceptable, and then to use that predicted temperature to (1) control the temperature of the integrated circuit, and (2) to design the integrated circuit with modified design tolerances knowing the integrated circuit will be operated in accordance with the predicted temperature.

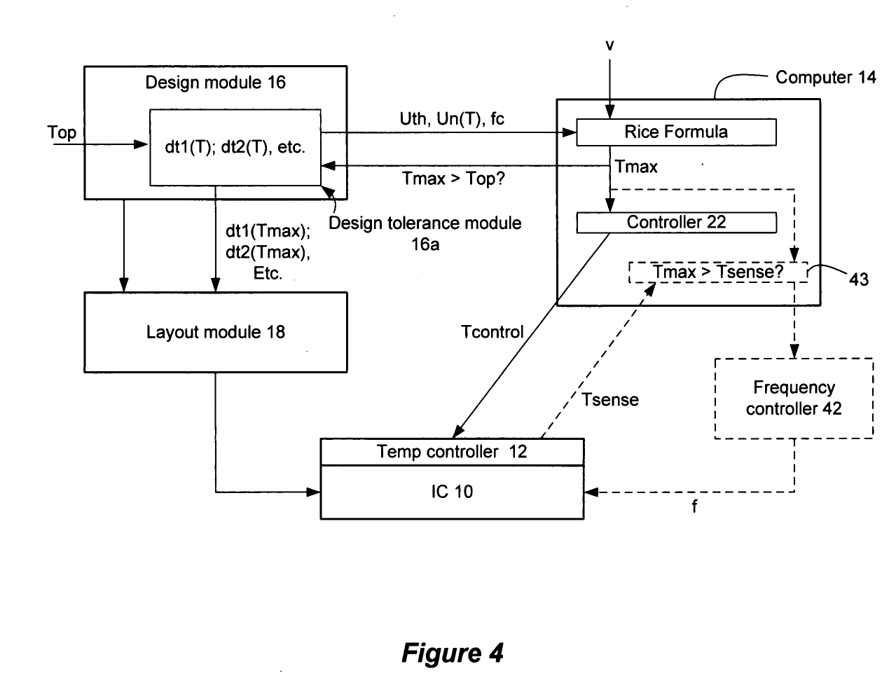

A computer-based system for effectuating these goals in shown in FIG. 4 in block diagram form. First, an integrated circuit (IC) 10 to benefit from the disclosed technique is shown, and is coupled to a temperature controller 12. The temperature controller 12 operates in accordance with a control signal, Tcontrol, and seeks to keep the IC 10 at the temperature prescribed by Tcontrol. The temperature controller 12 can constitute any means for heating or cooling (usually, cooling) the IC to a desired set point temperature, and can include any of the IC cooling techniques discussed briefly and incorporated within the Background section above. Of course, controlling the temperature of an IC 10 can comprise the use of feedback, in which the IC's temperature is measured to decide whether heating or cooling needs to be increased by the temperature controller 12. That is, temperature controller 12 may include a temperature sensor as well as means for holding the IC 10 to which it is coupled to a certain temperature.

Central to the disclosed technique is the use of a computer 14. The primary purpose of computer 14 is to compute an operational temperature, Tmax, which is optimal for a given IC 10 from a bit error rate perspective. In the disclosed example, this operation temperature is a maximum temperature, for the reason that most physical phenomena that can cause failures in an IC, such as the leakage mechanisms discussed earlier, are worsened with increasing temperature. Accordingly, operation of the IC at a tolerable temperature will thus comprise operation at or below a maximum temperature (hence, Tmax). Of course, the disclosed technique is not so limited, and for those failure mechanisms which worsen upon the use of colder temperatures, a minimum temperature, Tmin, can also be computed, although this is not further discussed for simplicity.

Computer 14 may comprise a stand-alone machine, but may also be implemented in integrated circuitry form, such as a microprocessor or micro controller, and may be present on the same printed circuit board on which the IC 10 is operating.

Inputs to computer 14 include those relevant to bit error rates. In a preferred embodiment, the input comprise various variables to the Rice formula, which is again depicted below for the reader's convenience:
v=(2/\sqrt{3})*exp(−Uth²/2Un²)*f_{c}
where v=the mean frequency of bit errors; Uth=a voltage threshold of a particular logic circuit involved in output the stream of bits, past which a bit error may be produced; Un=the root-mean-squared thermal noise voltage; and fc=the bandwidth of the thermal noise. Uth, Un, and fc are most logically provided to the computer 14 via a design module 16, which may comprise a portion of, or be coupled to, the computer 14.

The design module 16 is a standard module used in the design of integrated circuits, and includes the software tools necessary to design and simulate operation of an integrated circuit. The design module 16 in turn interfaces with a layout module 18, which takes the output of the design model 16, i.e., the circuit's design as well as appropriate design tolerances (dtn), and lays out the circuitry on the integrated circuit. As one skilled in the art will understand, such layout via module 18 generally amounts to the computation of data for the “tape out” of lithographic masks that will be used during IC manufacturing to dictate the positions and shapes of the various layers on the IC 10.

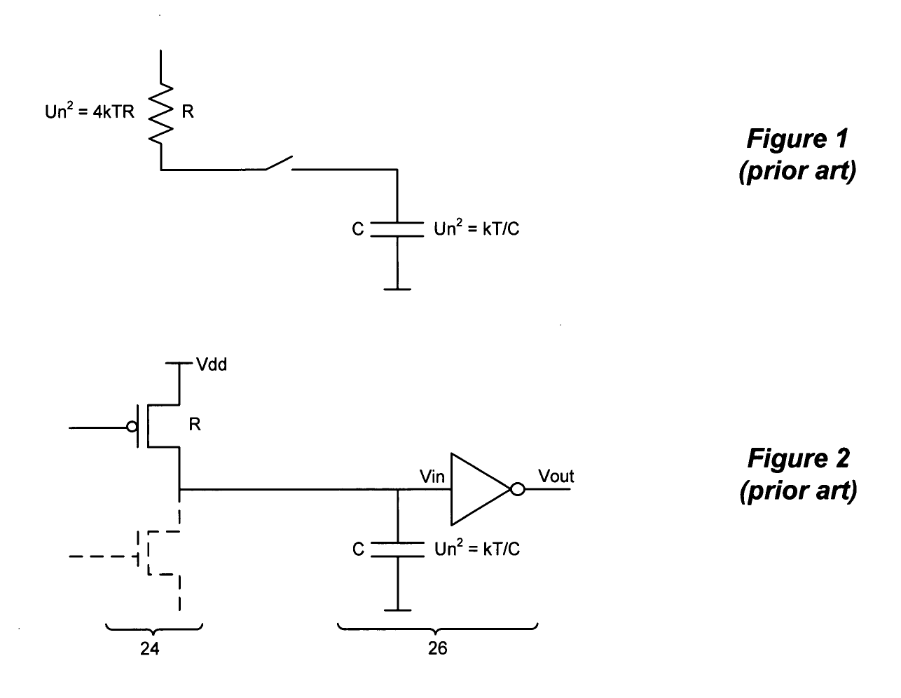

As just noted above, various variables to the Rice formula are input to the computer 14. Some variable are dictated by the basic design of the integrated circuit, such as voltage threshold (Uth), thermal noise voltage (Un), and bandwidth (fc), and hence may be provided by the design module 16. Un and fc are determined in accordance with whatever type of model best describes the general type of circuitry in the IC 10. Because the RC circuit of FIG. 1 well models both the thermal aspects and performance of typical logic gates in a CMOS circuit, such as the inverter circuitry of FIG. 2, the expressions discussed in the Background section in conjunction with these figures (Un=\sqrt{kT/C}; fc=1/(2πRC)) are preferred when using the disclosed technique to design and/or operate a CMOS IC 10. However, this is not strictly necessary, and other models and equations can be used as well.

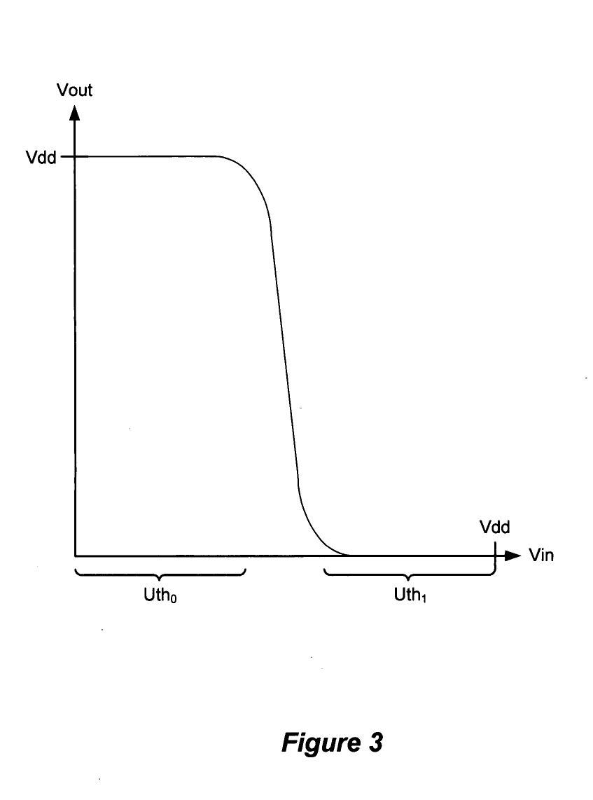

Other variables to the Rice formula are essentially based on constraints set by the user. For example, because the voltage threshold Uth for a given circuit might be subject to a user's preference—e.g., a user might prefer to set tighter constraints for Uth to render the design more conservative—Uth can be specified by the user. For example, even if Uth₀ or Uth₁ might simulate to be 1V for an integrated circuit operating at Vdd=2.5V, a user might decide that both of these voltage thresholds should be set at 0.5V. However, and as depicted in FIG. 3, Uth can also be estimated by the design module 16.

The bit error frequency, v, however, would normally be set by the user or by another system in accordance with what failure rates are tolerable for a given IC 10. For example, a personal computer in which the IC 10 will be placed may allow a bit error rate of only 10⁴ failures per year (a relatively low error rate when it is considered that the IC 10 may perform 10⁹ operations/second). In this case, a bit error rate of v=10⁴ would be input into the computer 14.

Regardless, what is important is that the computer receive as inputs, from whatever sources are appropriate in a given system, all of the variables specified by the Rice formula. From this, and because the rms thermal noise voltage Un is a function of temperature, the Rice formula can be solved for T. For example, if v=10⁴, Uth=1V,
10⁴=(2/\sqrt{3})*exp(−1²/(2kT/C))*1/(2πRC)
where R equal a typical CMOS input resistance, and C equals a typical CMOS input capacitance, such as might be set by the design module 16.

Of course, because a modem CMOS IC 10 comprises many devices, perhaps billions, the Rice formula may need to be modified, such as follows:
v=N*(2/\sqrt{3})*exp(−Uth²/2Un²)*f_{c}
where N equals the number of devices (transistors, etc.) on the IC 10.

Using the Rice formula, the computer 14 can solve the formula for a temperature, Tmax, i.e., the maximum temperature at which the IC 10 can be operated while statistically experiencing the desired rate of bit errors (v). There may be some error as concerns the predicted maximum temperature, because the modeling is off, etc. However, the exponential nature of the Rice formula, such error would have a logarithmic (i.e., lesser) effect on the predicted temperature, Tmax.

Once Tmax is computed, and in accordance with one embodiment of the invention, this temperature is used to control the operating temperature of the IC 10. Thus, the numerical value for Tmax may be sent to a controller 22 to derive a control signal, Tcontrol, understandable to the temperature controller 12 for the IC 10. With the temperature set point so established for the device, the temperature controller 12 controls the temperature of the IC accordingly, and as discussed above.

It will be appreciated that improved bit error rates (i.e., lower v) will generally require cooling of the IC, but may also permit higher temperature operation of the IC as well. Having said this, it should be understood that should Tmax compute to a value that is higher than the ambient operating temperature of the IC 10, little would be gained by actually heating the IC 10, as this would only facilitate effects such as thermal noise which are higher at higher temperatures. Instead, in such a case, the temperature controller would simply not control the temperature of the IC 10, resulting in an even lower bit error rate than the Rice formula predicted was permissible.

In reality, even though most failure mechanisms are accentuated at higher temperatures, other failure mechanisms are accentuated at lower temperatures. A good example might be that cracking of the packaging of the IC 10 is worsened as operating temperatures are lowered due to thermal mismatches between the IC 10 and its packaging material. In any event, while disclosed as producing a maximum temperature, Tmax, a minimum temperature could also be deduced by the computer 14 on the basis of similar modeling, and/or simply as a convenience measure. In short, the optimal operating temperature as deduced by the computer 14 could comprise a range instead of a single, permissible temperature.

In another embodiment of the invention, not only is the computer 14 used to deduce the optimal operating temperature for the IC 10, but the computer 14 is also used to assist in the design of the IC 10. This is also illustrated in FIG. 3. Basically, in this embodiment, the Rice formula is used to modify the design tolerances used to fabricate the IC 10. As noted earlier, design tolerances comprise various rules which affect the layout and positioning of the structures on the IC 10, and as shown in FIG. 3 such design tolerances (dt1, dt2, . . . dtn) are stored within a sub-module 16a within the design module 16. An example of a design tolerance is the junction spacing rule noted earlier, i.e., that junction spacing can be no smaller than 150 nanometers. Of course, in the design of a typical IC 10, there are many such design tolerances, and it is unnecessary to summarize such design tolerances here. However, as pointed out above, some design tolerances will vary as a function of temperature. Junction spacing is a good example, because there will be more junction-to-junction sub-threshold leakage at higher temperatures. Thus, smaller junction spacings can be used if the IC 10 is to be operated at lower temperatures, and longer junction spacings may be needed at higher temperatures.

Such temperature-dependent design tolerances can be used in conjunction with computer 14 to more logically design the IC 10 knowing it will be controlled to a certain operating temperature, and hence bit error rate via the Rice formula. Thus, initial design tolerances are chosen, which in turn may establish the various variables needed by the Rice formula, such as Uth, Un, and fc. In other words, some of these Rice formula variables may be dependent on the design tolerances, dtn. For example, the junction spacing can effect the input capacitance, which in turn affects Un and fc, and possibly Uth as well. An operating temperature for the IC 10, i.e., Top, is also chosen, and which may comprise a temperature dictated by an intended use of the to-be-fabricated IC 10, a user preference, etc. To the extent that the design tolerances dtn are temperature dependent, Top is involved in setting the initial values of the design tolerances.

Such initial design tolerances can be used to deduce or influence Rice formula variables Uth, Un, and fc, as just noted above, which are sent to computer 14. Assume further that a user defines a suitable bit error rate, v, for the IC 10 being designed, which too is sent to the computer 14. When these variables are input to the computer 14, the computer can solve for Tmax as discussed above.

At this point, if Tmax as calculated by computer 14 is higher than Top, this suggests that those design tolerances dependent on temperature, dtn(T), can be relaxed. For example, because performance of the IC 10, from a bit rate error perspective, would be adequate at Tmax, then some aspect of the design can be made more temperature sensitive. For example, perhaps the junction spacing design tolerance (e.g., dt1(T)) could be reduced from 150 nanometers to 120 nanometers.

If such a condition occurs, and design tolerances can be relaxed in this fashion, they are so relaxed at the design module 16 (e.g., from 150 nanometers to 120 nanometers). Thereafter, the estimation of Tmax can once again be performed. Because any of the Rice formula variable can be dependent on the changed design tolerance (e.g., dt1(T)), these variable are recalculated to new values. These newly-adjusted Rice formula variables can then be resent to the computer 14 to compute a new Tmax assuming the same bit error rate, v. Because the design tolerances has been relaxed, Tmax as calculated at the computer 14 would be expected to drop, which makes sense: because dt1(T) is relaxed and is more temperature sensitive, a lower temperature (Tmax) will render the same bit error rate (v).

It can then be considered once again whether Tmax as newly calculated is higher than the desired operating temperature, Top. If so, perhaps the design tolerance(s) can be further relaxed, etc. In short, through use of the disclosed technique, the design tolerances can be iteratively adjusted and ultimately input to the Rice formula to arrive at an appropriate operating temperature for the IC 10.

In this iterative process, once it has been determined that Tmax is no longer substantial greater than the desired operating temperature Top within some range of permissible error, Tmax can simply (and preferably) be chosen as the new operating temperature for the IC 10 to be designed in accordance with the modified design tolerances. This new operating temperature can be effectuated in the to-be-fabricated IC 10 via control signal Tcontrol, temperature controller 12, etc. Alternatively once a condition of Tmax<Top is met, Tmax may simply be set to Top, and the temperature of the IC 10 controlled accordingly, although this may amount to bit error rates a bit higher than what was initially desired (i.e., v).

Thus, when the Rice formula is used in the context of designing an IC 10, and in the context of control of the IC's operating temperature, potential benefits are had. As just seen, an IC as initially designed may be subject to relaxed tolerances, knowing that the IC 10 will be used in a temperature controlled manner. As a result of relaxed tolerances, design of the IC 10 at the design module 16 and layout module 18 is rendered more flexible. For example, if the use of the disclosed technique allowed, to continue the example above, the junction spacing to be reduced from 150 nanometers to 120 nanometers, the IC 10 can be made smaller, or more devices may be placed on the original area slated for IC 10. Such permissible minimization thus benefits the entire manufacturing process, which may now allow IC 10 to be processed more cheaply, but without significant concerns that relaxed design tolerances used will give rise to an impermissible frequency of bit errors.

Of course, while the disclosed technique would generally preferably operate to relax the design tolerances of an IC, the same technique can be used to identify potential design problems and to tighten design tolerances. For example, if the technique initially renders the condition that Tmax (as derived) is smaller than Top (the desired operating temperature), then this would suggest that the design of the integrated circuit is too relaxed, and that bit error rates (v) would be impermissibly high as the IC was initially designed. In such a circumstance, it might be necessary to tighten the design tolerances, for example, by increasing the junction spacing from 150 to 165 nanometers. Such a new design tolerance, as reflected in the Rice formula variables, can then be used by the computer 14 to once again calculate Tmax, and to compare it once again to Top, etc. In short, this technique can also be used to highlight and solve potential thermal problems in a designed IC.

In an alternative embodiment, temperature control is achieved via control of the operating or clock frequency, f, of the IC 10. As is known, the operating frequency, f, is related to the power dissipation, P, in the IC 10 by the following formula:
P=C*Vdd²*f
where C is the total capacitive load of all of the switching circuits, and Vdd is the IC's power supply voltage.

Because power dissipation scales with temperature, reduced operating frequencies will result in lower operating temperatures for the IC 10, which in turn amounts to lower bit error rates per the Rice formula. Accordingly, lower operating frequencies can be used in lieu of temperature control (or in addition to temperature control) to achieve desired bit error rates. This alternative embodiment is shown in dotted lines in FIG. 4. As shown, Tmax is calculated per the Rice formula as mentioned above, as is sent to a comparator module 43, which is preferably contained inside the computer 14. (Tmax may also be used in conjunction with controller 22 to produce a temperature control signal, Tcontrol, to control the operation of the IC 10 as discussed above, but this is ignored for now). The comparator 43 also receives the current temperature of the IC 10 (Tsense), which as noted earlier is possible because temperature controller 12 preferably and usually will contain a temperature sensor.

At the comparator 43, Tsense and Tmax as computed are compared. If Tmax is greater than Tsense, this means the operating frequency is too high. (Alternative, it can mean that the IC 10 is not being set to a low enough temperature via temp controller 12, but as noted above, this is alternative means for lowering the operating temperature is ignored, although it can be used in conjunction with operating frequency control). Accordingly, a frequency controller 42 receives the results of this comparison. The frequency controller 42 may comprise part of the computer 14, but it may also comprise part of the printed circuit board (e.g., mother board) on which the IC 10 is operating. Such frequency controllers 42 are common and therefore are not further explained. If Tmax is greater than Tsense, the frequency controller 42 will reduce the operating frequency, f, presented to the IC. This ultimately will cause a reduction in temperature, Tsense. When Tsense is again compared to Tmax, the operating frequency, f, can be further lowered if necessary to bring Tmax and Tsense to parity.

In any event, through the use of this alternative embodiment, bit error rates can be predictably reduced via control of the operating frequency, f, of the IC 10. This is beneficial, because (1) it may not always be possible to control the operating temperature of the IC 10 through cooling, e.g., because of high ambient temperature conditions, and (2) because it is not always required that an IC 10 operate at its maximum operating frequency, thus providing some flexibility to use operating frequency to control temperature, and ultimately bit error rates.

Although use of the Rice formula has been disclosed herein to quantify bit error rates and to allow for operational temperature and design optimization, other formulas or algorithms (collectively, “formulas”) predictive of bit error rates may also be used with the disclosed technique, including those that are pre-existing or might be developed in the future.

As noted above, the computer 14 may be used to determine either a single temperature or a range of temperatures. Both a single temperature and a range of temperature comprise a “operating temperature” for purposes of this disclosure.

It should be understood that the inventive concepts disclosed herein are capable of many modifications. To the extent such modifications fall within the scope of the appended claims and their equivalents, they are intended to be covered by this patent.

What is claimed is:

1. A method for controlling the operational temperature of an integrated circuit, comprising:
providing a computer, the computer for processing a formula for calculating a bit error rate as a function of temperature;
providing a desired bit error rate to the computer;
processing the formula at the computer to solve the formula for an operating temperature; and
operating the integrated circuit in accordance with the operating temperature using a temperature controller.

2. The method of claim 1, wherein the formula comprises the Rice formula.

3. The method of claim 1, wherein the formula is a function of logic voltage threshold, thermal noise threshold, and noise bandwidth.

4. The method of claim 1, wherein the operating temperature comprises a maximum operating temperature, and wherein operating the integrated circuit in accordance with the operating temperature comprises operating the integrated circuit at or below the maximum operating temperature.

5. The method of claim 1, wherein the temperature controller receives a temperature control signal from the computer.

6. The method of claim 1, wherein the at least one variable is provided to the computer from a design module for designing the integrated circuit.

7. A method for controlling the operational temperature of an integrated circuit, comprising:
providing a computer, the computer for processing a formula for calculating a bit error rate as a function of at least one variable which is dependent on temperature;
providing a desired bit error rate and the at least one variable to the computer;
processing the formula at the computer to solve the formula for an operating temperature; and
operating the integrated circuit in accordance with the operating temperature using a temperature controller.

8. The method of claim 7, wherein the formula comprises the Rice formula.

9. The method of claim 7, wherein the formula is a function of logic voltage threshold, thermal noise threshold, and noise bandwidth.

10. The method of claim 7, wherein the operating temperature comprises a maximum operating temperature, and wherein operating the integrated circuit in accordance with the operating temperature comprises operating the integrated circuit at or below the maximum operating temperature.

11. The method of claim 7, wherein the variable dependent on temperature comprises a thermal noise voltage.

12. The method of claim 11, wherein the thermal noise voltage comprises Un=\sqrt{kT/C}.

13. The method of claim 7, wherein the temperature controller receives a temperature control signal from the computer.

14. The method of claim 7, wherein the at least one variable is provided to the computer from a design module for designing the integrated circuit.

15. A method for controlling the operational temperature of an integrated circuit, comprising:
providing a computer, the computer for processing a formula, the formula comprising
v∝(2/\sqrt{3})*exp(−Uth²/2Un²)*f_{c}
where v=a mean frequency of bit errors, Uth=a voltage threshold, Un=a root-mean-squared (rms) thermal noise voltage, and fc=a bandwidth of the thermal noise;
providing a desired v, Uth, and Un to the computer, where Un is a function of temperature;
processing the formula at the computer to solve the formula for an operating temperature; and
operating the integrated circuit in accordance with the operating temperature using a temperature controller.

16. The method of claim 15, wherein the operating temperature comprises a maximum operating temperature, and wherein operating the integrated circuit in accordance with the operating temperature comprises operating the integrated circuit at or below the maximum operating temperature.

17. The method of claim 15, wherein Un=\sqrt{kT/C}.

18. The method of claim 15, wherein the temperature controller receives a temperature control signal from the computer.

19. A method for optimizing the design and operational temperature of an integrated circuit, comprising:
(a) providing a system, the system comprising
a computer, the computer for processing a formula for calculating a bit error rate as a function of temperature;
a design module having at least one design tolerance for the integrated circuit that varies as a function of temperature;
(b) providing a desired bit error rate and a desired operating temperature to the system;
(c) processing the formula at the computer to solve the formula for an optimal operating temperature;
(d) if the optimal operating temperature is different from the desired operating temperature, adjusting the at least one design tolerance and reprocessing the formula to revise the optimal operating temperature;
(e) repeating step (d) until the revised optimal operating temperature substantially equals the desired operating temperature; and
(f) designing the integrated circuit using the adjusted design tolerance.

20. The method of claim 19, wherein the formula comprises the Rice formula.

21. The method of claim 19, wherein the formula is a function of logic voltage threshold, thermal noise threshold, and noise bandwidth.

22. The method of claim 19, further comprising: (g) operating the designed integrated circuit at the desired operating temperature.

23. The method of claim 22, wherein the designed integrated circuit is operated at the desired operating temperature via a temperature controller.

24. The method of claim 22, wherein the desired operating temperature comprises a maximum desired operating temperature, and wherein step (g) comprises operating the integrated circuit at or below the maximum desired operating temperature.

25. A method for optimizing the design and operational temperature of an integrated circuit, comprising:
(a) providing a system, the system comprising
a computer, the computer for processing a formula for calculating a bit error rate as a function of at least one variable which is dependent on temperature;
a design module having at least one design tolerance for the integrated circuit that varies as a function of temperature, the design module for computing the at least one variable using the at least one design tolerance;
(b) providing a desired bit error rate and a desired operating temperature to the system;
(c) processing the formula at the computer to solve the formula for an optimal operating temperature;
(d) if the optimal operating temperature is different from the desired operating temperature, adjusting the at least one design tolerance and reprocessing the formula to revise the optimal operating temperature;
(e) repeating step (d) until the revised optimal operating temperature substantially equals the desired operating temperature; and
(f) designing the integrated circuit using the adjusted design tolerance.

26. The method of claim 25, wherein the formula comprises the Rice formula.

27. The method of claim 25, wherein the formula is a function of logic voltage threshold, thermal noise threshold, and noise bandwidth.

28. The method of claim 25, further comprising: (g) operating the designed integrated circuit at the desired operating temperature.

29. The method of claim 28, wherein the designed integrated circuit is operated at the desired operating temperature via a temperature controller.

30. The method of claim 29, wherein the temperature controller receives a temperature control signal from the computer.

31. The method of claim 28, wherein the desired operating temperature comprises a maximum desired operating temperature, and wherein step (g) comprises operating the integrated circuit at or below the maximum desired operating temperature.

32. The method of claim 25, wherein the variable dependent on temperature comprises a thermal noise voltage.

33. The method of claim 32, wherein the thermal noise voltage comprises Un=\sqrt{kT/C}.

34. A method for optimizing the design and operational temperature of an integrated circuit, comprising:
(a) providing a system, the system comprising
a computer, the computer for processing a formula, the formula comprising
v∝(2/\sqrt{3})*exp(−Uth²/2Un²)*f_{c}
where v=a mean frequency of bit errors, Uth=a voltage threshold, Un=a root-mean-squared (rms) thermal noise voltage, and fc=a bandwidth of the thermal noise;
a design module having at least one design tolerance for the integrated circuit that varies as a function of temperature, the design module for computing Un using the at least one design tolerance;
(b) providing a desired bit error rate and a desired operating temperature to the system;
(c) processing the formula at the computer to solve the formula for an optimal operating temperature;
(d) if the optimal operating temperature is different from the desired operating temperature, adjusting the at least one design tolerance and reprocessing the formula to revise the optimal operating temperature;
(e) repeating step (d) until the revised optimal operating temperature substantially equals the desired operating temperature; and
(f) designing the integrated circuit using the adjusted design tolerance.

35. The method of claim 34, further comprising: (g) operating the designed integrated circuit at the desired operating temperature.

36. The method of claim 35, wherein the designed integrated circuit is operated at the desired operating temperature via a temperature controller.

37. The method of claim 36, wherein the temperature controller receives a temperature control signal from the computer.

38. The method of claim 35, wherein the desired operating temperature comprises a maximum desired operating temperature, and wherein step (g) comprises operating the integrated circuit at or below the maximum desired operating temperature.

39. The method of claim 34, wherein the thermal noise voltage comprises Un=\sqrt{kT/C}.

40. A method for controlling the operational temperature of an integrated circuit, comprising:
providing a computer, the computer for processing a formula for calculating a bit error rate as a function of temperature;
providing a desired bit error rate and the at least one variable to the computer;
processing the formula at the computer to solve the formula for an optimal operating temperature;
operating the integrated circuit at an operational frequency;
sensing the actual operating temperature of the operating integrated circuit; and
comparing the actual operating temperature to the optimal operating temperature, and if dictated by the comparison, reducing the operating frequency of the integrated circuit.

41. The method of claim 40, wherein the formula comprises the Rice formula.

42. The method of claim 40, wherein the formula is a function of logic voltage threshold, thermal noise threshold, and noise bandwidth.

43. The method of claim 42 wherein the thermal noise voltage comprises Un=\sqrt{kT/C}.
